(19) United States
(12) Patent Application Publication
(10) Pub. No.: US 2005/0068196 A1
(43) Pub. Date: Mar. 31, 2005

(54) Automated enforcement of parking meters

(76) Inventor: Jeffrey Marin, Great Neck, NY (US)

Correspondence Address: Frank Chau, Esq.;F. CHAU & ASSOCIATES, LLP, 1900 Hempstead Turnpike, East Meadow, NY, 11554, US

(21) Appl. No.: 10/672,898

(22) Filed: Sep. 26, 2003

(51) Int. Cl. G08G 1/14

(52) U.S. Cl. 340/932.2; 705/13

(57) ABSTRACT

In one aspect of the present invention, a system is provided for automatically enforcing parking spaces. The system comprises a vehicle sensor for determining whether a vehicle is parked in the parking spaces and a vehicle identification device for capturing images of the vehicle. The system further comprises a parking meter. The parking meter comprises a processor, a memory, a file storage unit comprising a violation manager for determining whether a violation has occurred and generating a notice of violation, and a communications unit for transmitting the notice, and the images or unique characteristics of the vehicle, via a network to a central receiving office, wherein the central receiving office identifies the owner of the vehicle and creates a summons for the owner of the vehicle in response to the notice of violation.

### BACKGROUND OF THE INVENTION

1. Field of the Invention

The present invention relates to the field of parking meters, and, more particularly, to automated enforcement of parking meters.

2. Description of the Related Art

Parking meters allocate parking spaces for a limited amount of time. That is, by depositing money into a parking meter, a driver purchases a limited amount of time for which to park his or her vehicle in a particular parking space. The time purchased through the meter is the maximum amount of time the driver is allowed to park his or her vehicle in the parking space. Once the driver has exceeded his or her allotted time, the driver has committed a legal violation and is potentially liable for fines to the municipality (or a private entity) that owns the parking meter. A citation, which generally provides notice of the violation and a fine, may be attached directly to the vehicle, for example, under a wiper blade. Alternatively, the citation may be mailed directly to the vehicle owner, who can be identified, for example, by running the license plate of the vehicle through a license plate database. Because a municipality (or a private entity) can collect money from the parking meter itself and from fines in enforcing unpaid/expired parking meters, parking meters provide a significant source of revenue to municipalities.

Many municipalities are replacing traditional, single-bay/single-space parking meters with multi-bay/multi-space parking meters. Whereas the traditional single-bay parking meter accepts only coins, the multi-bay parking meter may accept any of a variety of payment options, including paper money, credit cards, debit cards, and smart cards. Because one multi-bay parking meter potentially replaces numerous single-bay parking meters, the multi-bay parking meter saves space and is easier to maintain. Further, money collected from multiple parking spaces can be retrieved from one multi-bay parking meter, as opposed to numerous single-bay parking meters.

Although the multi-bay parking meter provides many advantages over the single-bay parking meter, both the single-bay and the multi-bay parking meters currently require human enforcement. That is, enforcement of parking meters is typically carried out by parking enforcement officers using handheld citation devices. One of the problems with human enforcement is cost. Many municipalities simply cannot afford the cost of hiring parking enforcement officers. Another problem with human enforcement is lost revenue. Revenue is lost when a citation is not timely issued for an expired/unpaid parking meter. Each parking enforcement officer is typically assigned to enforce numerous parking meters and/or parking spaces. Consequently, the parking enforcement officer cannot logistically monitor every parking meter and/or parking space simultaneously. This is particularly troublesome in the case of single-bay parking meters where a parking enforcement officer would need to check each individual parking meter. However, even in the case of the multi-bay parking meter, a parking enforcement officer would still need to process and print a citation for each individual car. The process can take several minutes, and a parking enforcement officer typically can issue only one citation at any given time. Not only is such a task onerous and time-consuming, in many cases, the parking enforcement officer may not immediately recognize that time for another parking space has expired. Especially in a situation where several parking spaces expire near the same time, the drivers of the other vehicles may come back to their cars after the parking meter has expired but before a citation can be issued. As a result, the municipality loses the revenue from potential fine payments because the citation was not immediately issued when the parking meter expired or is determined to be unpaid.

The present invention is directed to overcoming, or at least reducing the effects of, one or more of the problems set forth above

### SUMMARY OF THE INVENTION

In one aspect of the present invention, a system is provided for automatically enforcing one or more parking spaces. The system comprises a vehicle sensor for determining whether a vehicle is parked in the one or more parking spaces and a vehicle identification device for capturing one or more images of one or more unique characteristics of the vehicle parked in the one or more parking spaces. The unique characteristics are used to identify an owner of the vehicle. The system further comprises a parking meter. The parking meter comprises a processor, a memory, a file storage unit comprising a violation manager for determining whether a violation has occurred and generating a notice of violation in response to the violation, and a communications unit for transmitting the notice of violation, and the one or more images or the one or more unique characteristics of the vehicle, via a network to a central receiving office, wherein the central receiving office identifies the owner of the vehicle from the one or more images and creates a summons for the owner of the vehicle in response to the notice of violation. The processor, the memory, the communications, and the file storage unit are connected via a system bus. The vehicle sensor and the vehicle identification device are operatively connected to the parking meter.

In another aspect of the present invention, a system is provided for automatically enforcing one or more parking spaces. The system comprises a vehicle sensor for determining whether a vehicle is parked in the one or more parking spaces and a vehicle identification device for capturing one or more images of one or more unique characteristics of the vehicle parked in the one or more parking spaces. The one or more unique characteristics are used to identify an owner of the vehicle. The system further comprises an interface device. The interface device includes a processor, a memory, a file storage unit comprising a violation manager for determining whether a violation has occurred and generating a notice of violation in response to the violation, a communications unit for transmitting the notice of violation, and the one or more images or the one or more unique characteristics of the vehicle, via a network to a central receiving office, and a module for interfacing with a parking meter. The central receiving office identifies the owner of the vehicle from the one or more images and creates a summons for the owner of the vehicle in response to the notice of violation. The processor, the memory, the communications unit, the file storage unit, and the module are connected via a system bus. The vehicle sensor and the vehicle identification device are operatively connected to the interface device.

In yet another aspect of the present invention, a system is provided for automatically enforcing one or more parking spaces. The system comprises a vehicle sensor for determining whether a vehicle is parked in the one or more parking spaces and a vehicle identification device for capturing one or more images of one or more unique characteristics of the vehicle parked in the one or more parking spaces. The one or more unique characteristics are used to identify an owner of the vehicle. The system further comprises a module for interfacing with a parking meter and an interface device. The interface device includes a processor, a memory, a file storage unit comprising a violation manager for determining whether a violation has occurred and generating a notice of violation in response to the violation, and a communications unit for transmitting the notice of violation, and the one or more images or the one or more unique characteristics of the vehicle, via a network to a central receiving office. The central receiving office identifies the owner of the vehicle from the one or more images and creates a summons for the owner of the vehicle in response to the notice of violation. The processor, the memory, the communications unit, the file storage unit, and the module are connected via a system bus. The vehicle sensor and the vehicle identification device are operatively connected to the interface device. The interface device is operatively connected to the module

### BRIEF DESCRIPTION OF THE DRAWINGS

The invention may be understood by reference to the following description taken in conjunction with the accompanying drawings, in which like reference numerals identify like elements, and in which:

FIG. 1 depicts a simplified block diagram of an automated parking enforcement system, in accordance with one illustrative embodiment of the present invention; and

FIG. 2 depicts a simplified block diagram of the multi-bay parking meter of FIG. 1, in accordance with one illustrative embodiment of the present invention.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachers herein, one of ordinary skill in the related art will be able to contemplate these and similar implementations of the present invention.

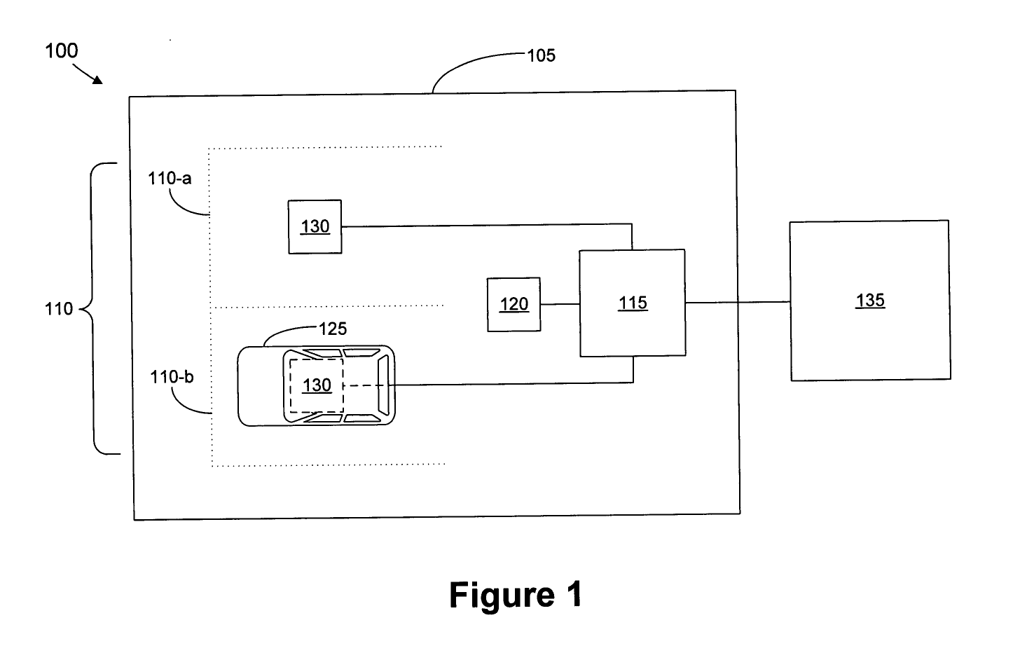

Referring now to FIG. 1, a simplified block diagram 100 of a system for automated enforcement of parking spaces is shown, in accordance with one embodiment of the present invention. An exemplary parking lot 105 is illustrated. The parking lot 105 comprises two parking spaces 110-a and 110-b (collectively “110”). Two parking spaces 110 are shown in FIG. 1 solely for illustrative purposes. It is understood that the invention is not so limited, and the parking lot 105 may comprise any number of parking spaces 110, as is contemplated by those skilled in the art. It is further understood that the parking lot 105 may be comprise several levels of parking spaces 110. Also, the parking lot 105 may be uncovered or covered such as a parking garage.

The parking lot 105 comprises a multi-bay parking meter 115. Although only one multi-bay parking meter 115 is shown in FIG. 1, it is understood that any number of parking meters can be used, as is contemplated by those skilled in the art. For example, a three-level parking garage may comprise two parking meters on each level for a total of six parking meters in the garage. It is further understood that the multi-bay parking meter 115 may be installed in any location inside or outside of the parking lot 105. In alternate embodiments, more than one single-bay parking meters may be used in lieu of the multi-bay parking meter.

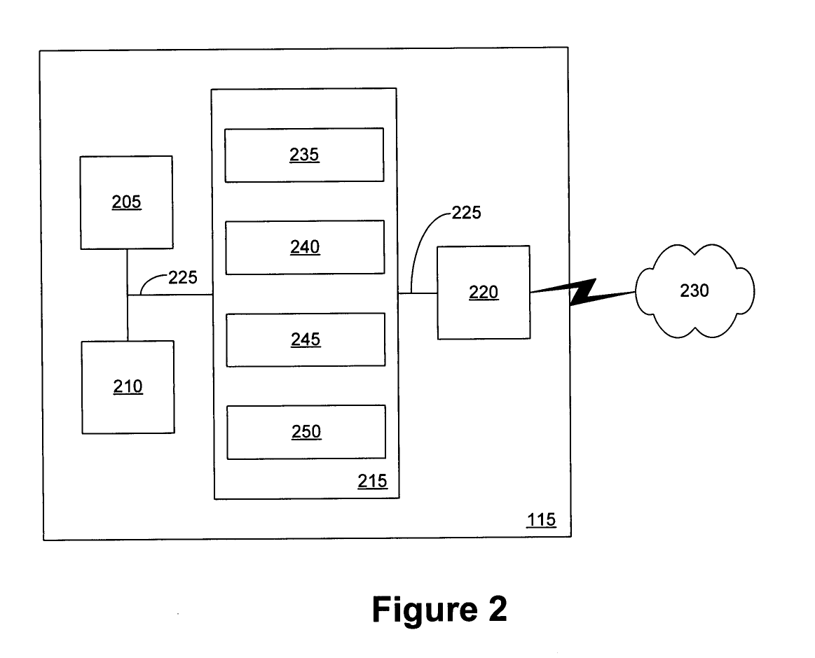

Referring now to FIG. 2, a simplified block diagram of the multi-bay parking meter 115 of FIG. 1 is illustrated, in accordance with one embodiment of the present invention. The multi-bay parking meter 115 comprises a processor 205, memory 210, a file storage unit 215, and a communications unit 220, connected via a system bus 225. The term “system bus” generally includes any mechanism for allowing the various components of the multi-bay parking meter 115 to communicate with each other as intended. The memory 210 may include any of a variety of memories including a main random access memory (“RAM”) and a read only memory (“ROM”). The file storage unit 215 generally provides nonvolatile storage of program and data files. The file storage unit 215 may include at least one hard disk drive and may include at least one floppy disk drive (with associated removable media). There may also be other devices such as a CD-ROM drive and optical drives (all with their associated removable media). Additionally, the file storage unit 215 may include drives of the type with removable media cartridges. One or more of the drives may be located at a remote location connected to the multi-bay parking meter 115 via a network 230, such as a local area network or Internet. The multi-bay parking meter 115 is connected to the network 230 via the communications unit 220, for example, a modem. As illustrated in FIG. 2 and described in greater detail below, the file storage unit 215 the multi-bay parking meter 115 comprises the following programs: a digital-to analog converter 235, a parking space availability unit 240, a violation manager 245, and a character recognition unit 250.

Referring again to FIG. 1, a vehicle identification device 120 is operatively connected to the multi-bay parking meter 115. The term “operatively connected” refers to any system for communication including wireless and wired technologies. The vehicle identification device 120 captures and/or identifies one or more unique characteristics of a vehicle 125. The one or more unique characteristics gathered by the vehicle identification device 120 are used to identify the owner of the vehicle 125, as described in greater detail below. The vehicle identification device 120 preferably comprises a device capable of capturing an image of the front and/or rear license plate of the vehicle 125. Alternatively, the vehicle identification device 120 comprises a device capable of capturing an image of the vehicle's state registration number or VIN (vehicle identification number). In one embodiment, the device capable of capturing an image is a digital still and/or video camera. In an alternate embodiment, an analog still and/or video camera may be used. The vehicle identification device 120 may further comprise a time/date logger (not shown). The time/date logger can log the time and date of each imaged captured by the vehicle identification device 120. In one embodiment, the time/date logger can superimpose on the image the time and date that an image is captured using any of a variety of techniques known to those skilled in the art.

It is understood that the vehicle identification device 120 may capture any number of images, as is contemplated by those skilled in the art. It is further understood that the vehicle identification device 120 may be operated continuously or in regular intervals. The vehicle identification device 120 may be controlled manually by a human or automatically through various software and/or hardware implementations, as contemplated by those skilled in the art. As illustrated in FIG. 1, only one vehicle identification device 120 is shown. It is understood, however, that any number of vehicle identification devices 120 may be used, as is contemplated by one skilled in the art. In one embodiment, the vehicle identification device 120 may comprise a robotic arm (not shown), such that the robotic arm is capable of moving the device capable of capturing an image to more than one of the parking spaces 110. Alternatively, the vehicle identification device 120 may comprise a swivel (not shown), such that the swivel is capable of swiveling the device capable of capturing an image to more than one of the parking spaces 110. Other embodiments may utilize any of a variety of devices known to those skilled in the art for moving the vehicle identification device 120, such that the device capable of capturing an image can capture images from more than one of the parking spaces 110.

The one or more images captured by the vehicle identification device 120 may be transmitted to the multi-bay parking meter 115. In one embodiment, the vehicle identification device 120 may comprise a digital-to-analog converter (not shown) for converting an analog image to a digital image. Alternatively, the multi-bay parking meter 115 may comprise a digital-to-analog converter 235 of FIG. 2. The transmission of the one or more images may occur continuously or at regular intervals. The transmission of the one or more images may be initiated manually by a human or automatically through various software and/or hardware implementations, as is contemplated by those skilled in the art.

Alternatively, the one or more images may be transmitted to an interface device (not shown), which transmits the one or more images to the multi-bay parking meter 115. For example, the multi-bay parking meter 115 may not provide a sufficient number of ports (or some other connection known to those skilled in the art) to operatively connect to the vehicle identification device 120. As such, the interface device may provide ports for connecting the vehicle identification device 120 to the multi-bay parking meter 115. The interface device may also provide additional processing power and/or memory for collecting the one or more images. The interface device may be installed inside the multi-bay parking meter 115, or it may be a separate unit from the multi-bay parking meter 115.

A vehicle sensor 130 is located in each parking space 110 and is operatively connected to the multi-bay parking meter 115. The vehicle sensor 130 detects whether a car is in a particular parking space 110. Alternatively, the vehicle sensor 130 may detect cars in more than one parking space 110. Any known sensor apparatus may be used, as is contemplated by those skilled in the art. For example, the vehicle sensor 130 may comprise a weight sensor that detects a minimum weight (ideally, a minimum vehicle weight, as is known to those skilled in the art) on the parking space. Alternatively, the vehicle sensor 130 may comprise an induction loop placed, for example, under the parking floor. In one embodiment, the vehicle sensor 130 maintains a log of the time and date of each car arriving and departing from the parking space 110. Alternatively, the multi-bay parking meter 115 may maintain the time and date log. Data collected by the vehicle sensor 130 is transmitted to the multi-bay parking meter 115. The data can be transmitted continuously or at regular intervals. Further, the data can be transmitted manually by a human or automatically through a variety of software and/or hardware implementations, as contemplated by those skilled in the art.

In one embodiment, the vehicle sensor 130 may be used by the parking space availability unit 240 of FIG. 2 to display the availability of parking spaces 110 to drivers inside and/or outside the parking lot 105. For example, if the parking lot 105 is a multi-level parking garage, a sign (not shown) can be placed at the entrance of the parking lot 105 and/or on each floor for displaying whether parking spaces 110 are available, and, if so, the number of the parking spaces 110 that are available. The sign may further display which parking spaces 110 are specifically available. The sign may comprise any of a variety displays, as contemplated by those skilled in the art. The vehicle availability unit 240 controls the sign. As such, a separate unit for controlling the sign and a separate induction loop for determining parking space availability is unnecessary.

The multi-bay parking meter 115 further comprises a violation manager 145 of FIG. 2 that keeps track of parking violations for each of the parking spaces 110. The violation manager may comprise a timer (not shown). A violation can occur in two basic ways: (1) an “unpaid” scenario; and (2) an “expired” scenario. In the unpaid scenario, the vehicle 125 parks in the parking space, for example, 110-b. At this point, the timer starts. The timer may be executed by the multi-bay parking meter 130 or the vehicle sensor 130. A driver of the vehicle 125 is given a finite amount of time in which he or she has to deposit a sufficient amount of money in the multi-bay parking meter 130. If the driver of the vehicle 125 fails to deposit the sufficient amount of money within that finite amount of time (i.e., the time on the timer exceeds the finite amount of time given to deposit the money), a violation for the vehicle 125 is recorded. In the expired scenario, the driver of the vehicle 125 timely deposits the sufficient amount of money in the multi-bay parking 130. Once the money is deposited, the driver is allowed to park his or her vehicle 125 for the purchased amount of time. This may be implemented by setting the timer once the driver deposits the sufficient amount of money. Once the driver parks his or her vehicle 125 in excess of the purchased amount of time (e.g., the timer exceeds the purchased amount of time), the violation for the vehicle 125 is recorded.

It is understood that the vehicle sensor 130 may comprise at least part of the violation manager 245 of FIG. 2. It is further understood that separate timers may be used for the unpaid and the expired scenarios. For instance, the vehicle sensor 130 may comprise a timer for the unpaid scenario and the violation manager 235 of FIG. 2 may comprise a timer for the expired scenario.

Notice of the violation and the one or more captured images of the violating vehicle 125 are sent to a central receiving office 135 via the network 230 of FIG. 2. Alternatively, the notice of the violation and the one or more captured images may be sent to the municipality that owns the multi-bay parking meter 115. The central receiving office 135 may be located inside or outside of the municipality where the multi-bay parking meter 115 is located. In one embodiment, the central receiving office 135 is capable of receiving notices of violations and captured images from numerous parking meters located in different municipalities.

The central receiving office 135 receives the notice of the violation and the one or more captured images, and, in response to receiving the notice, automatically processes the images to identify the owner of the vehicle 125. The owner of the vehicle 125 may be retrieved, for example, by comparing license plate information (i.e., state license plate is issued and unique identifier) of the vehicle 125 to vehicle records for the state given on the vehicle's 125 license plate or state registration sticker. The license plate information may be determined from the one or more captured images using a character recognition unit 250, as is known to those skilled in the art. The character recognition unit 250 preferably converts a digital image to corresponding alphanumeric characters. Alternatively, a human can view the one or more images to determine the alphanumeric characters. The alphanumeric characters may be used to search a database of the vehicle records to identify the owner of the vehicle 125. The vehicle records may be obtained, for example, through a state driving records agency, such as a state DMV (Department of Motor Vehicles) or a state DPS (Department of Public Safety).

Once the owner of the vehicle 125 is identified, a summons may be automatically created. The summons may also be mailed to the owner or the municipality. The summons can be created in cooperation with the municipality issuing the summons. The summons may state that a fine is to be paid as a result of the violation.

In one embodiment, the central receiving office 135 further automatically checks the vehicle records for any past unresolved or unpaid violations. For example, the owner of the vehicle 125 may have outstanding parking tickets. If the central receiving office 135 determines that the owner of the vehicle 125 has past unresolved or unpaid violations, the central receiving office 135 notifies the municipality that owns the multi-bay parking meter 115 of the current and past violations. If the vehicle 125 is still in the parking lot 105, then the municipality can impound or boot the vehicle accordingly.

The automated enforcement system described herein provides many advantages over existing systems. For example, enforcement of parking spaces in a parking lot or garage may be accomplished automatically and without human enforcement. Every parking space in a parking lot or garage may be simultaneously observed and enforced. Because a violation is immediately recorded when the violation occurs, no revenue is lost by the municipality that owns the parking meter. Furthermore, by accounting for whether a vehicle is in each parking space, a parking meter can control a display of available parking spaces without the use of a separate unit or induction loops.

It is understood that the violation manager 245 and the communications unit 220 of FIG. 2, as described in greater detail above, may be part of the interface device instead of the multi-bay parking meter 115. As such, the interface device may comprise its own processor, memory and file storage system. In this case, the interface device would be operatively connected to the multi-bay parking meter 115, and the multi-bay parking meter 115 would communicate to the interface device if (and possibly when) a sufficient amount of money is deposited. The multi-bay parking 115 may also communicate to the interface device how much time is purchased to park the vehicle and/or the amount of money that is deposited.

It is further understood that the system described herein may not comprise any parking meter, such as the multi-bay parking meter 115. Instead, the system may include a module for interfacing with a parking meter. The module may retrieve and/or receive any of a variety of information from the parking meter, as known to those skilled in the art. For example, the module may include some combination of software and/or hardware, as known to those skilled in the art, for determining when and/or how much money is deposited into the parking meter. The module may be part of the interface device, as described in greater detail above, or the module may be a separate component operatively connected to the interface device.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A system for automatically enforcing one or more parking spaces, comprising:
a vehicle sensor for determining whether a vehicle is parked in the one or more parking spaces;
a vehicle identification device for capturing one or more images of one or more unique characteristics of the vehicle parked in the one or more parking spaces, wherein the one or more unique characteristics are used to identify an owner of the vehicle; and
a parking meter comprising
a processor,
a memory,
a file storage unit comprising a violation manager for determining whether a violation has occurred and generating a notice of violation in response to the violation, and
a communications unit for transmitting the notice of violation, and the one or more images or the one or more unique characteristics of the vehicle, via a network to a central receiving office, wherein the central receiving office identifies the owner of the vehicle from the one or more images and creates a summons for the owner of the vehicle in response to the notice of violation;
wherein the processor, the memory, the communications unit, and the file storage unit are connected via a system bus, and
wherein the vehicle sensor and the vehicle identification device are operatively connected to the parking meter.

2. The system of claim 1, wherein the vehicle sensor is a weight sensor.

3. The system of claim 1, wherein the vehicle sensor is an induction loop.

4. The system of claim 1, wherein the vehicle identification device comprises at least one of a digital video camera, a digital still camera, an analog video camera, and an analog still camera.

5. The system of claim 4, wherein the vehicle identification device comprises a robotic arm attached to the at least one of a digital video camera, a digital still camera, an analog video camera, and an analog still camera.

6. The system of claim 4, wherein the vehicle identification device comprises a swivel attached to the at least one of a digital video camera, a digital still camera, an analog video camera, and an analog still camera.

7. The system of claim 4, wherein the vehicle identification device comprises an analog-to-digital converter for converting analog images to digital images.

8. The system of claim 1, wherein the vehicle identification device comprises a timer for determining the amount of time the vehicle parks in the one or more parking spaces.

9. The system of claim 1, wherein the vehicle identification device comprises a time and date logger that logs the time and date the one or more images are captured and superimposes the date and time in the one or more images.

10. The system of claim 1, wherein the parking meter is at least one of a single-bay parking meter and a multi-bay parking meter.

11. The system of claim 1, wherein the parking meter comprises a timer for determining the amount of time elapsed since money was deposited in the parking meter.

12. The system of claim 1, wherein the parking meter comprises an analog-to-digital converter for converting analog images to digital images.

13. The system of claim 1, wherein the parking meter comprises a time and date logger that logs the time and date the one or more images are captured and superimposes the date and time in the one or more images.

14. The system of claim 1, wherein the central receiving office mails the summons to the owner of the vehicle.

15. The system of claim 1, wherein the central receiving office comprises a database of vehicle records from one or more state driving records agencies.

16. The system of claim 1, wherein the parking meter further comprises a parking availability unit for determining availability of the one or more parking spaces.

17. The system of claim 16, further comprising a sign for displaying the availability of the one or more parking spaces.

18. The system of claim 1, wherein the one or more unique characteristics comprises at least one of a license plate, a state registration sticker, and a vehicle identification number (VIN).

19. The system of claim 1, wherein the communications unit comprises a modem.

20. The system of claim 1, wherein the vehicle sensor and the vehicle identification device are operatively connected to the parking meter via an interface device.

21. The system of claim 1, wherein the parking meter further comprises a character recognition unit for extracting the one or more unique characteristics of the vehicle from the one or more images.

22. The system of claim 1, wherein the central receiving office further comprises a character recognition unit for extracting the one or more unique characteristics of the vehicle from the one or more images.

23. A system for automatically enforcing one or more parking spaces, comprising:
a vehicle sensor for determining whether a vehicle is parked in the one or more parking spaces;
a vehicle identification device for capturing one or more images of one or more unique characteristics of the vehicle parked in the one or more parking spaces, wherein the one or more unique characteristics are used to identify an owner of the vehicle; and
an interface device comprising
a processor,
a memory,
a file storage unit comprising a violation manager for determining whether a violation has occurred and generating a notice of violation in response to the violation,
a communications unit for transmitting the notice of violation, and the one or more images or the one or more unique characteristics of the vehicle, via a network to a central receiving office, wherein the central receiving office identifies the owner of the vehicle from the one or more images and creates a summons for the owner of the vehicle in response to
the notice of violation; and
a module for interfacing with a parking meter;
wherein the processor, the memory, the communications unit, the file storage unit, and the module are connected via a system bus, and
wherein the vehicle sensor and the vehicle identification device are operatively connected to the interface device.

24. A system for automatically enforcing one or more parking spaces, comprising:
a vehicle sensor for determining whether a vehicle is parked in the one or more parking spaces;
a vehicle identification device for capturing one or more images of one or more unique characteristics of the vehicle parked in the one or more parking spaces, wherein the one or more unique characteristics are used to identify an owner of the vehicle;
a module for interfacing with a parking meter; and
an interface device comprising
a processor,
a memory,
a file storage unit comprising a violation manager for determining whether a violation has occurred and generating a notice of violation in response to the violation, and
a communications unit for transmitting the notice of violation, and the one or more images or the one or more unique characteristics of the vehicle, via a network to a central receiving office, wherein the central receiving office identifies the owner of the vehicle from the one or more images and creates a summons for the owner of the vehicle in response to
the notice of violation;
wherein the processor, the memory, the communications unit, and the file storage unit are connected via a system bus,
wherein the vehicle sensor and the vehicle identification device are operatively connected to the interface device, and
wherein the interface device is operatively connected to the module.
